(19) United States
(12) Patent Application Publication
(10) Pub. No.: US 2020/0102926 A1
(43) Pub. Date: Apr. 2, 2020

(54) SYSTEM AND METHOD TO EXTEND THE TIME LIMIT OF A REMOTE VEHICLE COMMAND

(71) Applicant: GM GLOBAL TECHNOLOGY OPERATIONS LLC, DETROIT, MI (US)

(72) Inventors: Kunal Jaggi, Troy, MI (US); Anurag Goyal, Plymouth (US); David T. Proefke, Troy, MI (US)

(21) Appl. No.: 16/148,053

(22) Filed: Oct. 1, 2018

(51) Int. Cl. F02N 11/08; H04W 4/80; H04W 4/40

(52) U.S. Cl. CPC F02N 11/0807; B60Q 1/04; H04W 4/40; H04W 4/80

(57) ABSTRACT

One general aspect includes a system to extend an activation command time duration, the system including: a memory configured to include one or more executable instructions and a processor configured to execute the executable instructions, where the executable instructions enable the processor to: receive an activation command from a remote entity; in response to the activation command, activate an engine of a vehicle; maintain the engine in an active state for a duration of time; establish a short-range wireless connection (SRWC) with a mobile computing device; and in response to the SRWC being established with the mobile computing device, extend the duration of time the engine is maintained in the active state.

### INTRODUCTION

It is well known for people to use their smart phones to remotely start their vehicles from anywhere in the world. This option is very convenient for anyone beyond the range in which their keyfob or phone can pair/link up with the vehicle. However, it can be annoying for someone who has remotely activated their vehicle to later arrive at the vehicle and find out that it has turned itself back off. Therefore, it is desirable to provide a system and method that will make it more likely for a remotely activated vehicle to remain turned on by the time its owner arrives. Furthermore, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system to extend an activation command time duration, the system including: a memory configured to include one or more executable instructions and a processor configured to execute the executable instructions, where the executable instructions enable the processor to: receive an activation command from a remote entity; in response to the activation command, activate an engine of a vehicle; maintain the engine in an active state for a duration of time; establish a short-range wireless connection (SRWC) with a mobile computing device; and in response to the SRWC being established with the mobile computing device, extend the duration of time the engine is maintained in the active state. Other embodiments of this aspect include corresponding computer systems, apparatus, and computer programs recorded on one or more computer storage devices, each configured to perform the actions of the methods.

Implementations may include one or more of the following features. The system further including, in response to the SRWC being established with the mobile computing device, activate one or more exterior-mounted vehicle lamps. The system further including sending a status notification to the remote entity after the engine has been activated or has failed to activate, the status notification configured to cause the remote entity to send a success/failure notification to the mobile computing device. The system where the activation command is generated by the remote entity in response to a remote start attempt from the mobile computing device or a virtual assistant. The system where the engine is deactivated at an end of the duration of time unless vehicle operations are physically activated from within a vehicle cabin. The system where the activation command is received from the remote entity only when the mobile computing devices is at a location outside a range capable of establishing SRWC between the processor and the mobile computing device. The system where the duration of time is extended by ten (10) minutes. Implementations of the described techniques may include hardware, a method or process, or computer software on a computer-accessible medium.

One general aspect includes a vehicle including a telematics unit, the telematics unit configured to: receive an activation command from a data center; in response to the activation command, activate an engine of the vehicle; maintain the engine in an active state for a duration of time; establish a short-range wireless connection (SRWC) with a mobile computing device; and in response to the SRWC being established with the mobile computing device, extend the duration of time the engine is maintained in the active state. Other embodiments of this aspect include corresponding computer systems, apparatus, and computer programs recorded on one or more computer storage devices, each configured to perform the actions of the methods.

Implementations may include one or more of the following features. The vehicle where the telematics unit is further configured to, in response to the SRWC being established with the mobile computing device, activate one or more exterior-mounted vehicle lamps. The vehicle where the telematics unit is further configured to send a status notification to the data center after the engine has been activated or has failed to activate, the status notification configured to cause the data center to send a success/failure notification to the mobile computing device. The vehicle where the activation command is generated by the remote entity in response to a remote start attempt from the mobile computing device or a virtual assistant. The vehicle where the engine is deactivated at an end of the duration of time unless vehicle operations are physically activated from within a vehicle cabin. The vehicle where the activation command is received from the data center only when the mobile computing devices is at a location outside a range capable of establishing SRWC between the telematics unit and the mobile computing device. The vehicle where the duration of time is extended by ten (10) minutes. Implementations of the described techniques may include hardware, a method or process, or computer software on a computer-accessible medium.

One general aspect includes a method to extend an activation command time duration, the method including: receiving, at a processor, an activation command from a remote entity; in response to the activation command, via the processor, activating an engine of a vehicle; maintaining, via the processor, the engine in an active state for a duration of time; establishing, via the processor, a short-range wireless connection (SRWC) with a mobile computing device; and in response to the SRWC being established with the mobile computing device, via the processor, extending the duration of time the engine is maintained in the active state. Other embodiments of this aspect include corresponding computer systems, apparatus, and computer programs recorded on one or more computer storage devices, each configured to perform the actions of the methods.

Implementations may include one or more of the following features. The method further including, in response to the SRWC being established with the mobile computing device, via the processor, activating one or more exterior-mounted vehicle lamps. The method further including sending, via the processor, a status notification to the remote entity after the engine has been activated or has failed to activate, the status notification configured to cause the remote entity to send a success/failure notification to the mobile computing device. The method where the activation command is generated by the remote entity in response to a remote start attempt from the mobile computing device or a virtual assistant. The method where the engine is deactivated at an end of the duration of time unless vehicle operations are physically activated from within a vehicle cabin. The method where the duration of time is extended by ten (10) minutes. Implementations of the described techniques may include hardware, a method or process, or computer software on a computer-accessible medium.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system that is capable of utilizing the system and method disclosed herein;

FIG. 2 is a flowchart of an exemplary process to extend an activation command time duration in accordance with one or more exemplary embodiments; and

FIG. 3 depicts an application of an exemplary aspect of the process of FIG. 2 in accordance with one or more exemplary embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

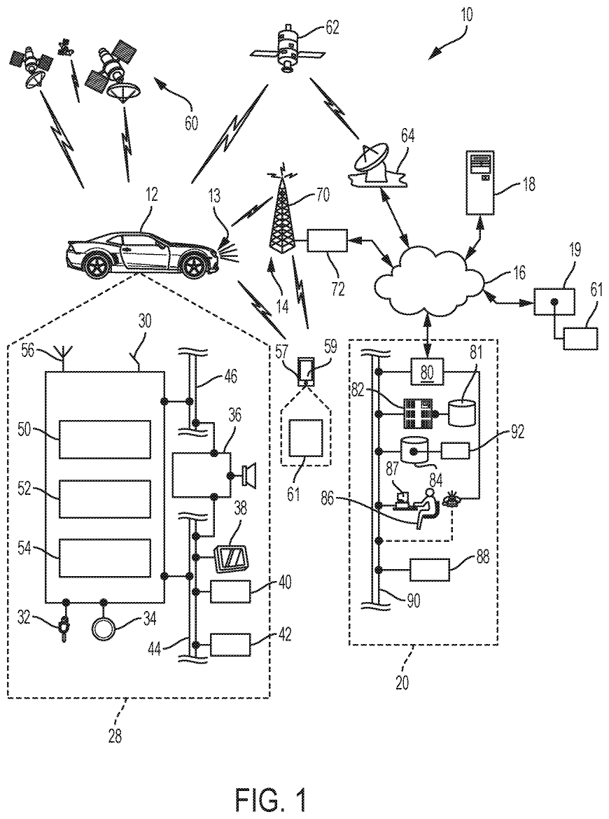

With reference to FIG. 1, there is shown an operating environment that includes, among other features, a mobile vehicle communications system 10 that can be used to implement the method disclosed herein. Communications system 10 generally includes a vehicle 12, one or more wireless carrier systems 14, a land communications network 16, a computer 18, a virtual assistant 19, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including, but not limited to, motorcycles, trucks, busses, sports utility vehicles (SUVs), recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), WIFI, Bluetooth and Bluetooth Low Energy, a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket transceiver device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor 86 or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to standards such as LTE or 5G and thus includes a standard cellular chipset 50 for voice communications like hands-free calling, a wireless modem for data transmission (i.e., transceiver), an electronic processing device 52, at least one digital memory device 54, and an antenna system 56. It should be appreciated that the modem can either be implemented through software that is stored in the telematics unit and is executed by processor 52, or it can be a separate hardware component located internal or external to telematics unit 30. The modem can operate using any number of different standards or protocols such as, but not limited to, WCDMA, LTE, and 5G. Wireless networking between vehicle 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile computing device 57, such as a smart phone, personal laptop computer, smart wearable device, or tablet computer having two-way communication capabilities, a netbook computer, or any suitable combinations thereof. The mobile computing device 57 can include computer processing capability and memory (not shown), a transceiver capable of communicating with wireless carrier system 14, a user interface 59, and/or a GPS module 63 capable of receiving GPS satellite signals and generating GPS coordinates based on those signals. User interface 59 may be embodied as a touch-screen graphical interface capable of user interaction as well as displaying information which may be through graphical user interfaces (GUIs). Examples of the mobile computing device 57 include the iPhone™ manufactured by Apple, Inc. and the Droid™ manufactured by Motorola, Inc. as well as others. While the mobile computing device 57 may include the ability to communicate via cellular communications using the wireless carrier system 14, this is not always the case. For instance, Apple manufactures devices such as the various models of the iPad™ and iPod Touch™ that include the processing capability, user interface 59, and the ability to communicate over a short-range wireless communication link such as, but not limited to, WIFI and Bluetooth. However, the iPod Touch™ and some iPads™ do not have cellular communication capabilities. Even so, these and other similar devices may be used or considered a type of wireless device, such as the mobile computing device 57, for the purposes of the method described herein.

Mobile device 57 may be used inside or outside of vehicle 12, and may be coupled to the vehicle by wire or wirelessly. The mobile device may also be configured to provide services according to a subscription agreement with a third-party facility or wireless/telephone service provider. It should be appreciated that various service providers may utilize the wireless carrier system 14 and that the service provider of the telematics unit 30 may not necessarily be the same as the service provider of the mobile devices 57.

When using a short-range wireless connection (SRWC) protocol (e.g., Bluetooth/Bluetooth Low Energy or Wi-Fi), mobile computing device 57 and telematics unit 30 may pair/link one with another when within a wireless range (e.g., prior to experiencing a disconnection from the wireless network). In order to pair, mobile computing device 57 and telematics unit 30 may act in a BEACON or DISCOVERABLE MODE having a general identification (ID); SRWC pairing is known to skilled artisans. The general identifier (ID) may include, e.g., the device's name, unique identifier (e.g., serial number), class, available services, and other suitable technical information. Telematics unit 30 may also use the general identification (ID) to authenticate the mobile computing device 57 as belonging to the user of vehicle 12 before pairing/linking occurs.

Mobile computing device 57 and telematics unit 30 may also pair via a non-beacon mode. In these instances, the data center 20 may participate in pairing mobile computing device 57 and telematics unit 30. For example, the data center 20 may initiate the inquiry procedure between the telematics unit 30 and mobile computing device 57. And data center 20 may identify mobile computing device 57 as belonging to the user of vehicle 12 and then receive from the mobile computing device 57 it's unique mobile device identifier and authorize the telematics unit 30 via the wireless communication system 14 to pair with this particular ID.

Once SRWC is established, the devices may be considered bonded as will be appreciated by skilled artisans (i.e., they may recognize one another and/or connect automatically when they are in a predetermined proximity or range of one other. In other words—they may become, at least temporarily, network participants). Data center 20 may also authorize SRWC on an individual basis before completion.

The mobile computing device 57 additionally has a vehicle-related software application 61 (e.g., RemoteLink™ by OnStar, myChevrolet™ by General Motors, etc.) resident on its memory. This vehicle app 61 may be downloaded (e.g., from an online application store or marketplace) and stored on the device's electronic memory. When the vehicle app 61 is installed on the mobile computing device 57, in one or more embodiments, the user can be presented with option to turn on a proprietary messaging service (e.g., Apple's Push Notification Services (APNS) service or Firebase Cloud Messaging (FCM) service).

In the examples disclosed herein, the vehicle app 61 enables the mobile computing device user to manage remote start attempts from mobile computing device 57. In particular, the vehicle app 61 enables the user to sign up for a remote start service and to register one or more specific vehicles 12 with the remote start service. This information may be stored in the memory of mobile computing device 57 and accessible by vehicle app 61 which may be implementing one or more GUIs via user interface 59. This information may also be transmitted from the vehicle app 61 to a remotely located mobile integration gateway 92 (discussed below) for storage in the user's account in the database 84.

The vehicle app 61 also allows the user to initiate a remote start attempt from the mobile computing device 57. Upon receiving a user input indicating that the user would like to initiate a remote start, the vehicle app 61 generates a remote start attempt message to send to the mobile integration gateway 92 (discussed below). In some examples, the vehicle app 61 is programmed to know which vehicle identifier to include with the remote start attempt message because the user has registered his/her vehicle(s) 12 with remote start service.

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services provided in connection with one or more vehicle system modules 42 (VSM); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18 or virtual assistant 19, for other purposes, such as fleet management. Also, new or updated map data can be downloaded to the GPS module 40 from the data center 20 via the telematics unit 30.

Apart from the audio system 36 and GPS module 40, the vehicle 12 can include other VSMs 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests.

As examples, one VSM 42 can be an engine control module (ECM) that controls various aspects of engine operation such as fuel ignition and ignition timing, another VSM 42 can be a powertrain control module (PCM) that regulates operation of one or more components of the vehicle powertrain, and another VSM 42 can be a body control module (BCM) that governs various electrical components located throughout the vehicle, like the vehicle's power door locks and exterior-mounted vehicle lamps 13. According to one embodiment, the ECM 42 is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art.

The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM, media streaming services (e.g., PANDORA RADIO™, SPOTIFY™, etc.), satellite radio, CD, DVD, and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions (i.e., capable of GUI implementation). Audio system 36 may also generate at least one audio notification to announce such third-party contact information is being exhibited on display 38 and/or may generate an audio notification which independently announces the third-party contact information. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more cellular network infrastructures (CNI) 72, as well as any other networking components required to connect wireless carrier system 14 with land network 16. Each cell tower 70 includes sending and receiving antennas and a base station, with the base stations from different cell towers being connected to the CNI 72 either directly or via intermediary equipment such as a base station controller. Cellular system 14 can implement any suitable communications technology, including for example, analog technologies such as AMPS, or the newer digital technologies such as, but not limited to, 4G LTE and 5G. As will be appreciated by skilled artisans, various cell tower/base station/CNI arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure (i.e., a network of interconnected computing device nodes). One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer (e.g., a SIP Presence server) where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or data center 20, or both. A computer 18 can also be used for providing Internet connectivity such as DNS services or as a network address server that uses DHCP or other suitable protocol to assign an IP address to the vehicle 12.

Virtual assistant 19 can be a computing device with an installed software agent adapted to perform tasks or services for a user (e.g., AMAZON™ ALEXA™, GOOGLE ASSISTANT™, APPLE SIRI™, etc.) and accessible via a private or public network such as the Internet. As is generally known, virtual assistant 19 may include a microphone for receiving verbal commands, a speaker for providing audible notifications, and a display for exhibiting information corresponding to the audible notifications. Virtual assistant 19 is capable of certain functions such as, but not limited to, voice interaction, music playback, making to-do lists, setting alarms, streaming podcasts, playing audiobooks, and providing weather, traffic, sports, and other real-time information (e.g., news). Virtual assistant 19 can also control several smart devices using itself as a home automation system. Users are able to extend the Alexa capabilities by installing “skills” such as, for example, an adapted version of vehicle related software application 61, discussed above, which may be downloaded (e.g., from an online application store or marketplace).

Data center 20 is designed to provide the vehicle electronics 28 with a number of different system backend functions and, according to the exemplary embodiment shown here, generally includes one or more switches 80, server 82, database 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live advisor 86 by regular phone, backend computer 87, or to the automated voice response system 88 using VoIP. Server 82 can incorporate a data controller 81 which essentially controls the operations of server 82. Server 82 may control data information as well as act as a transceiver to send and/or receive the data information (i.e., data transmissions) from one or more of the databases 84, telematics unit 30, and mobile computing device 57.

Controller 81 is capable of reading executable instructions stored in a non-transitory machine readable medium (database 84) and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (i.e., a transceiver), connected between the land communications network 16 and local area network 90.

Data transmissions are passed via the modem to server 82 and/or database 84. Database 84 can store account information such as vehicle dynamics information and other pertinent subscriber information. Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

Database 84 could also be designed to store information in the form of executable instructions such as, but not limited to, numerous application program interface (API) suites accessed, executed, and/or governed by server 82. Moreover, in certain embodiments, these API suites may be accessible to the system user, data center 20, or one or more third parties. As examples, one API suite can be the mobile integration gateway (MIG) 92. In some instances, MIG 92 is a gateway that facilitates the servicing of requests from the vehicle app 61 stored on the mobile computing device 57. For example, the MIG 92 may be a node that is equipped for interfacing with the mobile computing device 57 and its messaging service (which may be part of a different network).

MIG 92 can also be equipped to execute service requests from the vehicle-related application 61. For example, MIG 92 can facilitate the detection of a vehicle remote start attempt by the remote mobile computing device 57. In response, MIG 92 can construct custom message(s) that is/are to be transmitted to the mobile computing device 57 to keep a user of the device 57 apprised of the status of the remote start attempt. Also in response to receiving the remote start attempt request, the MIG 92 facilitates the transmission of the one or more activation signals to the telematics unit 30 (e.g., a remote start signal, etc.). Once received at the telematics unit 30, the telematics unit 30 may send a corresponding activation signal that triggers ECM 42 (or another appropriate VSM) to turn the vehicle on (e.g., start ignition, power up, etc.). Upon the vehicle turning on or failing to turn on, telematics unit 30 will transmit a message to the MIG 92 indicating that the vehicle 12 has successfully been started or has failed to start. The MIG 92 in turn generates a success/failure notification to be sent to the mobile computing device 57. This message may be a pop-up or push notification that informs the user of the mobile computing device 57 that vehicle 12 has been started or has failed to start.

### Method

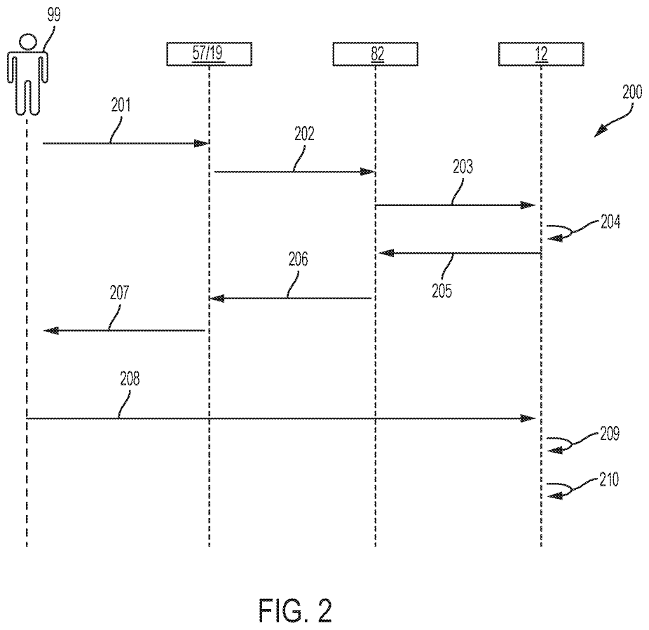

Now turning to FIG. 2, there is shown an embodiment of a method 200 for extending the set time duration in which vehicle 12 is maintained in an active state after being turned on by a remote activation signal from MIG 92 at server 82. One or more aspects of notification method 200 may be completed through telematics unit 30 which may include an electronic processing device 52 (processor) to execute one or more programs contained electronic memory 54. One or more ancillary aspects of method 200 may also be completed by data center 20 (remote entity), for example, via controller 81 of server 82 accessing a mobile integration gateway (MIG) 92 stored in databases 84. One or more ancillary aspects of method 200 may be completed by mobile computing device 57, virtual assistant 19, and exterior-mounted vehicle lamps 13. Method 200 is supported by the telematics unit 30 being configured to pair/link with the mobile computing device 57 (i.e., establish a short range wireless communication protocol (SRWC protocol)) when within proximity of vehicle 12 as well as authenticate the mobile computing device 57 as being associated with the vehicle 12 (i.e., as belonging to user 99). Method 200 is also supported by the BCM 44 being configured to illuminate one or more of the exterior-mounted vehicle lamps 13. These configurations may be established by a manufacturer at or around the time of the vehicle's assembly.

In various embodiments, method 200 begins at 201 in which the user 99 initiates a remote start attempt from their mobile computing device 57. Moreover, in this step, the user 99 should be at a location that resides outside a range in which the telematics unit 30 and mobile computing device 57 can pair/link together via a SRWC protocol. For example, the user may be using their mobile computing device 57 at a distance of greater than 100 meters from telematics unit 30.

In other embodiments, method 200 begins at 201 in which the user 99 initiates a remote start attempt through a virtual assistant 19. Moreover, in this step, the user 99 should be at a location that resides outside a range in which the telematics unit 30 and mobile computing device 57 can pair/link together via a SRWC protocol. For example, the user may be using virtual assistant 19 while within their home (e.g., as a smart device hardwired in the interior of their home).

In other embodiments, the remote start attempt may be initiated by a virtual alarm clock aspect of the vehicle related software application 61. As such, using their mobile computing device 57 or virtual assistant 19, the user will schedule a time for a remote start attempt to be initiated. For example, the user may set the remote start attempt to be sent off at 6:00 pm (when they generally leave work). Alternatively, the vehicle app 61 will configure the remote start attempt to let MIG 92 know to transmit its corresponding activation signal at a set time. Thus, when the remote start attempt is received at server 82, MIG 92 will know not to send the activation signal until the designated time.

In step 202, the remote start attempt is received at server 82 of data center 20. As explained above, in this step, upon being received, controller 81 will implement the MIG 92 to facilitate the remote start attempt. In step 203, which may be some time after the remote start attempt is received (e.g., when a virtual alarm clock is implemented), server 82 will implement MIG 92 to transmit one or more activation signals (an activation command) to the telematics unit 30.

In step 204, the activation signal is received by telematics unit 30 and, in response to this signal, telematics unit 30 will collaborate with engine control module (ECM) 42 to start the ignition and activate the vehicle's 12 engine (and other systems such as, for example, the HVAC system). In this step, moreover, the engine will be maintained in an active state (i.e., the engine will remain running) for a certain amount of time. As such, once a time limit is reached and full operation of vehicle 12 has not been attained by physical activation from within the vehicle's cabin, telematics unit 30 will cause the engine to be deactivated (i.e., turn the engine off). This type of physical activation occurs when a user sitting in the driver seat either presses the vehicle ignition button while possessing their key fob or turns their key when it has been inserted into the ignition socket—as is generally known.

In step 205, telematics unit 30 will transmit a message to the MIG 92 indicating that the vehicle 12 has successfully been started or, if for some reason, has failed to start. In step 206, the status notification is received by server 82. Moreover, in this step, upon being received, controller 81 will implement the MIG 92 to generate and transmit a success/failure notification to be sent to the mobile computing device 57 or virtual assistant 19. In step 207, the success/failure notification is received by mobile computing device 57 and displayed on the user interface 59 for the user 99 to see and understand that their vehicle's 12 engine has been turned on (or has failed to turn on). Alternatively, in step 207, the success/failure notification is received by virtual assistant 19 and provided audibly by the speaker of the virtual assistant 19 device for the user 99 to hear and understand that their vehicle's 12 engine has been turned on (or has failed to turn on). When the virtual assistant 19 further includes a display, the success/failure notification received by virtual assistant 19 can additionally/alternatively be displayed on the display.

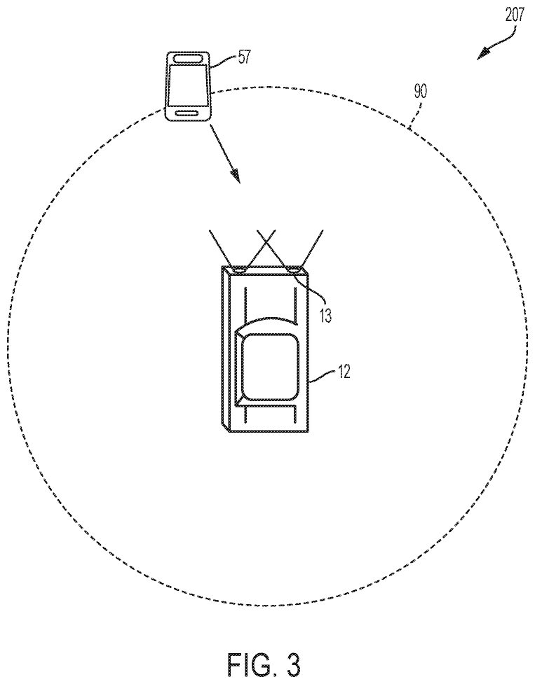

In step 208 (with additional reference to FIG. 3) some time after the vehicle's engine has been activated (e.g., 5 minutes), the user 99 moves past the perimeter of range 90, in which the telematics unit 30 and the mobile computing device 57 (which is held on the person of user 99) can pair/link via the SRWC protocol. As stated above, this range 90 may be a distance of 100 meters. Moreover, in this step, telematics unit 30 recognizes the mobile computing device 57 is within this range 90 and then completes the SRWC paring/linking process with the mobile computing device 57.

In certain embodiments, in optional step 209, returning to FIG. 2, telematics unit 30 may authenticate the mobile computing device 57 as belonging to the user, before pairing/linking with the mobile computing device 57. For example, telematics unit 30 may review the serial number of the mobile computing device 57, contained in the general identifier (ID) information, and verify that this number is the same serial number stored in memory 54 that has been associated with the user 99, which was received at the first instance in which pairing/linking occurred between the devices.

In step 210, in response to pairing/linking with the mobile computing device 57, telematics unit 30 will extend the amount of time in which the engine will be maintained in the active state and thus extend the time limit before the engine is to be deactivated. For example, telematics unit 30 will extend the amount of time the engine is running by ten (10) minutes. This extension of time will ensure that the engine is not inconveniently turned off just before the user 99 reaches their vehicle 12. In various embodiments, telematics unit 300 will make the extension of time only one time and ignore any instances in which the mobile computing device 57 moves outside of the perimeter of range 90 and then reenters the range 90, to prevent unintentional initiations of the remote start time extension.

In certain embodiments, moreover, in response to pairing/linking with the mobile computing device 57, telematics unit 30 may also collaborate with BCM 42 to provide power to the exterior-mounted vehicle lamps 13 and cause them to be illuminated. This will add the convenience of letting the user 99 to better see where their vehicle 12 was last parked. After step 210, method 200 will move to completion.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A system to extend an activation command time duration, the system comprising:
a memory configured to comprise one or more executable instructions and a processor configured to execute the executable instructions, wherein the executable instructions enable the processor to:
receive an activation command from a remote entity;
in response to the activation command, activate an engine of a vehicle;
maintain the engine in an active state for a duration of time;
establish a short-range wireless connection (SRWC) with a mobile computing device; and
in response to the SRWC being established with the mobile computing device, extend the duration of time the engine is maintained in the active state.

2. The system of claim 1, further comprising, in response to the SRWC being established with the mobile computing device, activate one or more exterior-mounted vehicle lamps.

3. The system of claim 1, further comprising send a status notification to the remote entity after the engine has been activated or has failed to activate, the status notification configured to cause the remote entity to send a success/failure notification to the mobile computing device.

4. The system of claim 1, wherein the activation command is generated by the remote entity in response to a remote start attempt from the mobile computing device or a virtual assistant.

5. The system of claim 1, wherein the engine is deactivated at an end of the duration of time unless vehicle operations are physically activated from within a vehicle cabin.

6. The system of claim 1, wherein the activation command is received from the remote entity only when the mobile computing devices is at a location outside a range capable of establishing SRWC between the processor and the mobile computing device.

7. The system of claim 1, wherein the duration of time is extended by ten (10) minutes.

8. A vehicle comprising a telematics unit, the telematics unit configured to:
receive an activation command from a data center;
in response to the activation command, activate an engine of the vehicle;
maintain the engine in an active state for a duration of time;
establish a short-range wireless connection (SRWC) with a mobile computing device; and
in response to the SRWC being established with the mobile computing device, extend the duration of time the engine is maintained in the active state.

9. The vehicle of claim 8, wherein the telematics unit is further configured to, in response to the SRWC being established with the mobile computing device, activate one or more exterior-mounted vehicle lamps.

10. The vehicle of claim 8, wherein the telematics unit is further configured to send a status notification to the data center after the engine has been activated or has failed to activate, the status notification configured to cause the data center to send a success/failure notification to the mobile computing device.

11. The vehicle of claim 8, wherein the activation command is generated by the data center in response to a remote start attempt from the mobile computing device or a virtual assistant.

12. The vehicle of claim 8, wherein the engine is deactivated at an end of the duration of time unless vehicle operations are physically activated from within a vehicle cabin.

13. The vehicle of claim 8, wherein the activation command is received from the data center only when the mobile computing devices is at a location outside a range capable of establishing SRWC between the telematics unit and the mobile computing device.

14. The vehicle of claim 8, wherein the duration of time is extended by ten (10) minutes.

15. A method to extend an activation command time duration, the method comprising:
receiving, at a processor, an activation command from a remote entity;
in response to the activation command, via the processor, activating an engine of a vehicle;
maintaining, via the processor, the engine in an active state for a duration of time;
establishing, via the processor, a short-range wireless connection (SRWC) with a mobile computing device; and
in response to the SRWC being established with the mobile computing device, via the processor, extending the duration of time the engine is maintained in the active state.

16. The method of claim 15, further comprising, in response to the SRWC being established with the mobile computing device, via the processor, activating one or more exterior-mounted vehicle lamps.

17. The method of claim 15, further comprising sending, via the processor, a status notification to the remote entity after the engine has been activated or has failed to activate, the status notification configured to cause the remote entity to send a success/failure notification to the mobile computing device.

18. The method of claim 15, wherein the activation command is generated by the remote entity in response to a remote start attempt from the mobile computing device or a virtual assistant.

19. The method of claim 15, wherein the engine is deactivated at an end of the duration of time unless vehicle operations are physically activated from within a vehicle cabin.

20. The method of claim 15, wherein the duration of time is extended by ten (10) minutes.
